(19) United States
(12) Patent Application Publication
(10) Pub. No.: US 2019/0096155 A1
(43) Pub. Date: Mar. 28, 2019

(54) ELECTRONIC VALUE MANAGEMENT APPARATUS, ELECTRONIC VALUE MANAGEMENT SYSTEM, ELECTRONIC VALUE MANAGEMENT METHOD, AND NON-TRANSITORY STORAGE MEDIUM

(71) Applicant: NEC CORPORATION, Tokyo (JP)

(72) Inventor: Takeo OHNO, Tokyo (JP)

(73) Assignee: NEC CORPORATION, Tokyo (JP)

(21) Appl. No.: 16/082,147

(22) PCT Filed: Jan. 11, 2017
(86) PCT No.: PCT/JP2017/000544

§ 371 Date: Sep. 4, 2018

(30) Foreign Application Priority Data
Mar. 10, 2016 (JP) 2016-046520

(51) Int. Cl. G07F 7/08; G07F 7/10; G06Q 20/06; G06Q 20/10; G06Q 20/26; G06Q 20/34; G06Q 20/36; G06Q 30/02

(52) U.S. Cl. CPC G07F 7/0866; G07F 7/1008; G06Q 20/06; G06Q 30/0225; G06Q 20/26; G06Q 20/341; G06Q 20/3674; G06Q 20/105

(57) ABSTRACT

In order to solve the above problem, there is provided an electronic value management apparatus (10) including a reception unit (11) that receives an input of a load amount, and a loading unit (12) that performs a loading process of subtracting the load amount from a balance of an electronic value of a providing entity stored in a first storage unit and adding the load amount to a balance of an electronic value of a receiving entity stored in a second storage unit.

### TECHNICAL FIELD

The present invention relates to an electronic value management apparatus, an electronic value management system, an electronic value management method, and a program.

### BACKGROUND ART

Related techniques are disclosed in Patent Documents 1 and 2.

Patent Document 1 discloses a card settlement system which includes a card settlement terminal capable of reading information recorded in a card settlement unit and a computer of a settlement organization capable of executing settlement by the card settlement unit, which are connected through a communication line, and executes a settlement process of a transaction according to an electronic message transmitted from the card settlement terminal. In this system, a plurality of member store identification codes can be input to the card settlement terminal, so that a plurality of member stores can jointly use the card settlement terminal.

Patent Document 2 discloses a settlement processing apparatus that processes settlement using points. Based on a settlement record including the number of points that a customer uses for settlement, the settlement processing apparatus decreases the number of points of the customer stored in a customer-holding-points storage unit and increases the unpaid amount for a store stored in an unpaid amount information storage unit.

### RELATED DOCUMENT

### Patent Document

[Patent Document 1] Japanese Patent Application Publication No. 2003-108892

[Patent Document 2] Japanese Patent Application Publication No. 2002-117314

### SUMMARY OF THE INVENTION

### Technical Problem

An electronic value issuing company gives authority to load over customers to a plurality of member stores. When receiving a predetermined amount of cash from a customer, accordingly, a member store to which the authority is given loads a predetermined amount of electronic value, for example, on an electronic card of the customer.

As a settlement method between the electronic value issuing company and the member store for the loading, for example, an example of monthly settlement is considered. That is, at the closing date of the month, the member store pays in a lump cash received from customers for loading in the current month to the electronic value issuing company. Further, the member store receives compensation for execution of loading process from the electronic value issuing company.

In the case of the above settlement method, inconvenience may occur such as a member store running off with cash received from customers without paying it to an electronic value issuing company or illegally loading an electronic value. Neither Patent Document 1 nor Patent Document 2 provides means for solving the problem. According to the present invention, it is an object to provide a technique for alleviating inconveniences that may occur in connection with a loading process of an electronic value.

### Solution to Problem

According to the present invention, there is provided an electronic value management apparatus including a reception unit that receives an input of a load amount; and a loading unit that performs a loading process of subtracting the load amount from a balance of an electronic value of a providing entity stored in a first storage unit and adding the load amount to a balance of an electronic value of a receiving entity stored in a second storage unit.

Further, according to the present invention, there is provided an electronic value management system including the electronic value management apparatus; an apparatus having a first storage unit that stores a balance of an electronic value of a providing entity; and an apparatus having a second storage unit that stores a balance of an electronic value of a receiving entity.

Further, according to the present invention, there is provided an electronic value management method executed by a computer, the method including a reception step of receiving an input of a load amount; and a loading step of performing a loading process of subtracting the load amount from a balance of an electronic value of a providing entity stored in a first storage unit and adding the load amount to a balance of an electronic value of a receiving entity stored in a second storage unit.

Further, according to the present invention, there is provided a program causing a computer to function as: a reception unit that receives an input of a load amount; and a loading unit that performs a loading process of subtracting the load amount from a balance of an electronic value of a providing entity stored in a first storage unit and adding the load amount to a balance of an electronic value of a receiving entity stored in a second storage unit.

### Advantageous Effects of Invention

According to the present invention, it is possible to alleviate inconveniences that may occur in connection with a loading process of an electronic value.

### BRIEF DESCRIPTION OF THE DRAWINGS

The foregoing and other objects, features and advantages will become more apparent from the following description of preferred exemplary example embodiments and the accompanying drawings.

FIG. 1 is a diagram conceptually showing an example of a hardware configuration of an apparatus of a present example embodiment.

FIG. 2 is a diagram for explaining an overview of an electronic value management system of the present example embodiment.

FIG. 3 is a diagram schematically showing an example of information managed by an account management server of the present example embodiment.

FIG. 4 is a diagram for explaining an application example of the electronic value management system of the present example embodiment.

FIG. 5 is an example of a functional block diagram of the electronic value management apparatus of the present example embodiment.

FIG. 6 is a flowchart showing an example of a process flow of the electronic value management apparatus of the present example embodiment.

FIG. 7 is a diagram for explaining an application example of the electronic value management system of the present example embodiment.

FIG. 8 is a diagram for explaining an application example of the electronic value management system of the present example embodiment.

FIG. 9 is a diagram for explaining an application example of the electronic value management system of the example embodiment.

FIG. 10 is a diagram for explaining an example of use information of the present example embodiment.

FIG. 11 is a diagram schematically showing an example of information managed by an account management server of the present example embodiment.

FIG. 12 is a diagram schematically showing an example of information managed in a store performing settlement using the electronic value of the present example embodiment.

FIG. 13 is a diagram schematically showing an example of information managed in a store performing settlement using the electronic value of the present example embodiment.

### DESCRIPTION OF EMBODIMENTS

First, an example of a hardware configuration of an apparatus (electronic value management apparatus) of the present example embodiment will be described. Each unit included in the apparatus of the present example embodiment is realized by any combination of hardware and software of any computer, mainly using a central processing unit (CPU), a memory, a program to be loaded into the memory, and a storage unit such as a hard disk storing the program (can store programs stored in advance in the stage of shipping the apparatus, and also store programs downloaded from a storage medium such as a compact disc (CD) or a server on the Internet), and a network connection interface. Those skilled in the art will understand that there are various modifications in the realization methods and apparatuses.

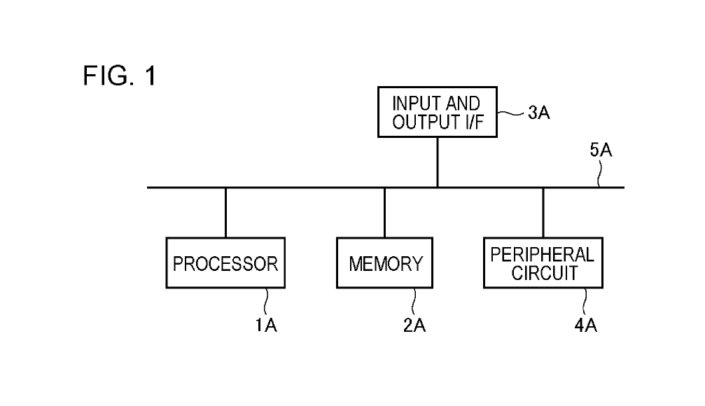

FIG. 1 is a block diagram illustrating a hardware configuration of an apparatus of the present example embodiment. As shown in FIG. 1, the apparatus includes a processor 1A, a memory 2A, an input and output interface 3A, a peripheral circuit 4A, and a bus 5A. The peripheral circuit includes various modules.

The bus 5A is a data transmission path through which the processor 1A, the memory 2A, the peripheral circuit 4A and the input and output interface 3A mutually transmit and receive data. The processor 1A is, for example, an arithmetic processing apparatus such as a central processing unit (CPU) or a graphics processing unit (GPU). The memory 2A is, for example, a memory such as a random access memory (RAM) or a read only memory (ROM). The input and output interface 3A includes an interface for acquiring information from an external apparatus, an external server, an external sensor, or the like. The processor 1A issues commands to the modules and performs calculations based on the calculation results.

Hereinafter, the present example embodiment will be described. Note that, the functional block diagram used in the description of the following exemplary example embodiment shows blocks of functional units rather than a configuration of a hardware unit. These drawings show that each apparatus is configured by a single apparatus, but configuration means of each apparatus is not limited to this. That is, it may be a physically separated configuration or a logically divided configuration. Note that, the same reference numerals may be attached to the same configuration components, and the description thereof will not be repeated as appropriate.

### First Example Embodiment

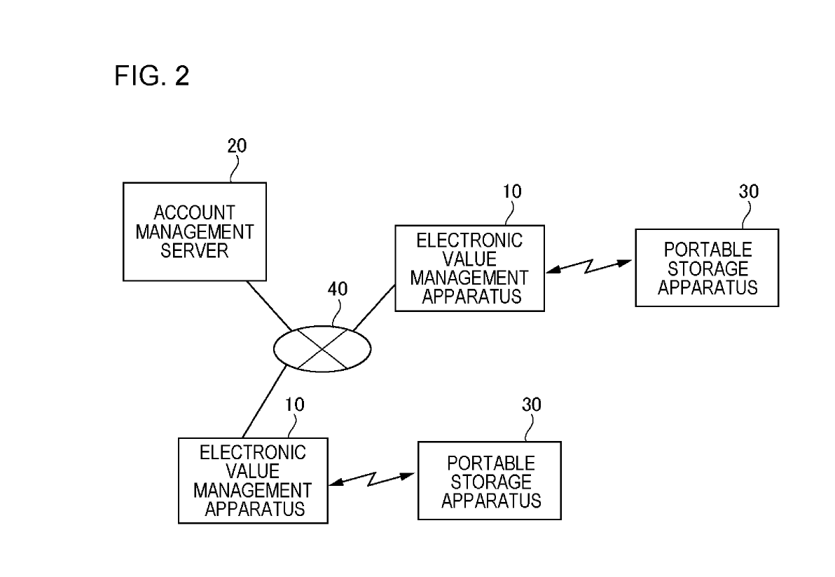

First, with reference to FIG. 2, the overview of an electronic value management system of the present example embodiment will be described. The electronic value management system of the present example embodiment includes an electronic value management apparatus 10, an account management server 20, and a portable storage apparatus 30.

The electronic value management apparatus 10 and the account management server 20 are connected to a network 40 such as the Internet, and are in a state in which information can be mutually transmitted and received. The electronic value management apparatus 10 and the portable storage apparatus 30 have a function of communicating with each other under a predetermined communication standard. For example, the settlement terminal and the portable storage apparatus 30 may perform communication when the positional relationship between them satisfies a predetermined condition (for example, short-range wireless communication), may perform communication when they contact each other, and may perform communication when they are mutually connected by wires. Communication standards are not particularly limited, and any communication standard can be adopted.

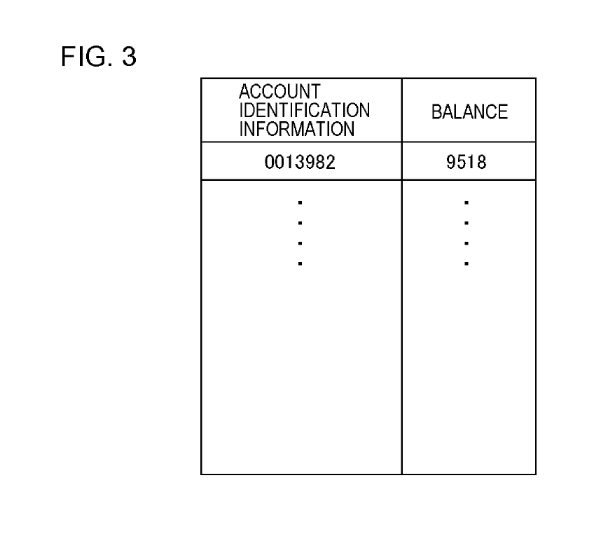

The account management server 20 is a server that manages online accounts of electronic values, and online accounts of each of a plurality of account holders are managed here. As shown in FIG. 3, the account management server 20 manages account identification information for identifying each of a plurality of online accounts and the balance of each online account (balance of electronic value) in association with each other. Note that, other information such as the name, address, and birth date of the account holder may be managed by the account management server 20. A system that manages online accounts can be implemented according to any technology in the related art.

The account management server 20 may be accessed with a terminal such as a personal computer (PC) or a smartphone, in addition to a dedicated terminal. By operating these terminals, information on the online account (balance or the like) may be viewed, an electronic value may be transferred between online accounts, an electronic value may be added to an online account, or use information described in the following example embodiments may be given.

The portable storage apparatus 30 is a portable storage apparatus held by an electronic value user. For example, an electronic card, a smartphone, a tablet, a mobile phone, an electronic tag, and the like are illustrated, but the portable storage apparatus 30 is not limited thereto. In the portable storage apparatus 30, the balance of the electronic value is stored.

For example, the customer loads the electronic value on the portable storage apparatus 30 at a store or the like, and use it at the time of payment at the store or the like. For example, at the time of payment at a store, the customer informs the clerk of the payment with the electronic value instead of payment in cash. Accordingly, the clerk performs a predetermined operation for receiving the payment with the electronic value, on the settlement terminal.

Thereafter, the customer makes a predetermined settlement terminal provided in the store and the portable storage apparatus 30 of the customer communicable. Then, the payment amount is subtracted from the balance of the electronic value stored in the portable storage apparatus 30, and the payment amount is added to the electronic value on the store side stored in the predetermined storage apparatus. This completes payment.

For example, the payment amount may be added to the electronic value of the online account of the store managed by the account management server 20. In the case of this example, for example, the settlement terminal may store in advance the account identification information of the online account of the store. Then, when the payment amount is subtracted from the balance of an electronic value stored in the portable storage apparatus 30 in settlement, accordingly, the settlement terminal may request the account management server 20 to perform increase by the payment amount on the online account corresponding to the account identification information.

The settlement terminal and the portable storage apparatus 30 have a function of communicating with each other under a predetermined communication standard. For example, the settlement terminal and the portable storage apparatus 30 may perform communication when the positional relationship between them satisfies a predetermined condition (for example, short-range wireless communication), may perform communication when they contact each other, and may perform communication when they are mutually connected by wires. Communication standards are not particularly limited, and any communication standard can be adopted.

In addition, the electronic value user (a customer, a member store, or the like) can transfer some or all of the electronic value remaining in its online account to the portable storage apparatus 30 for management.

The electronic value management apparatus 10 is installed in a store or the like. The loading of an electronic value on the portable storage apparatus 30 is executed through the electronic value management apparatus 10.

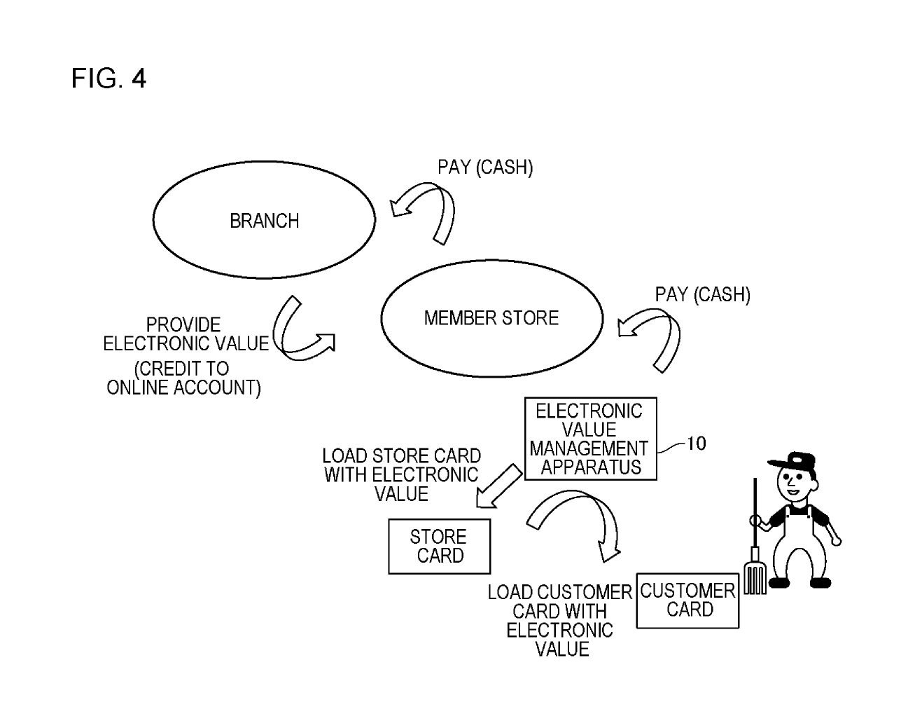

Next, an application example of the electronic value management system of the present example embodiment will be described with reference to FIG. 4. Three types of entities appear: a branch, a member store, and a customer.

The branch is an entity that manages issuance of an electronic value. The branch gives authority to load over customers to a plurality of member stores.

A member store which is given the authority to load pays a predetermined amount of cash to the branch. The branch credits the electronic value of the amount corresponding to the paid amount, to the online account of the member store.

The member store has a portable storage apparatus 30 for a store. The member store transfers at least a part of the electronic value remaining in the online account of the store to the portable storage apparatus 30 (a store card shown in FIG. 4) through the electronic value management apparatus 10.

More specifically, the store clerk of a member store operates a predetermined input device (for example, a touch panel display, a physical button, a keyboard, a mouse, a microphone, or the like) to input the account identification information of the online account of the store, and the amount (transfer amount) of the electronic value to be transferred to the portable storage apparatus 30, to the electronic value management apparatus 10. Then, the electronic value management apparatus 10 transmits to the account management server 20, a transfer request of an electronic value for the above-described transfer amount from the online account corresponding to the input account identification information to the portable storage apparatus 30. Here, in a case where the balance is less than the transfer amount, the account management server 20 transmits an error such as “insufficient balance” to the electronic value management apparatus 10. Then, the electronic value management apparatus 10 outputs the error.

In a case where the error has not occurred, the account management server 20 transmits a transfer permission to the electronic value management apparatus 10. Then, the electronic value management apparatus 10 outputs a guide for causing the portable storage apparatus 30 to communicate with the electronic value management apparatus 10. Thereafter, the clerk of the member store sets the portable storage apparatus 30 and the electronic value management apparatus 10 in a communicable state (for example, a mutual positional relationship satisfying a predetermined condition, contact, wired connection, or the like). Then, the transfer amount is added to the balance of the electronic value stored in the portable storage apparatus 30, and a transfer completion notification is transmitted from the electronic value management apparatus to the account management server 20. Accordingly, the account management server 20 subtracts the transfer amount from the balance of the online account of the store.

As another example, account identification information of an online account of a member store may be stored in the portable storage apparatus 30 of the member store. The clerk of a member store operates a predetermined input device (for example, a touch panel display, a physical button, a keyboard, a mouse, a microphone, or the like) to input the amount (transfer amount) of the electronic value to be transferred to the portable storage apparatus 30 to the electronic value management apparatus 10.

Thereafter, the clerk makes the portable storage apparatus 30 and the electronic value management apparatus 10 communicable. Then, the electronic value management apparatus 10 acquires the account identification information of the online account of the member store stored in the portable storage apparatus 30. Then, the electronic value management apparatus 10 transmits to the account management server 20, a transfer request of an electronic value for the above-described transfer amount from the online account corresponding to the input account identification information to the portable storage apparatus 30. The subsequent process is the same as above.

Returning to FIG. 4, the customer pays a predetermined amount of cash to the member store and requests to load the electronic value. The loading is performed through the electronic value management apparatus 10. Hereinafter, the configuration of the electronic value management apparatus 10 will be described in detail.

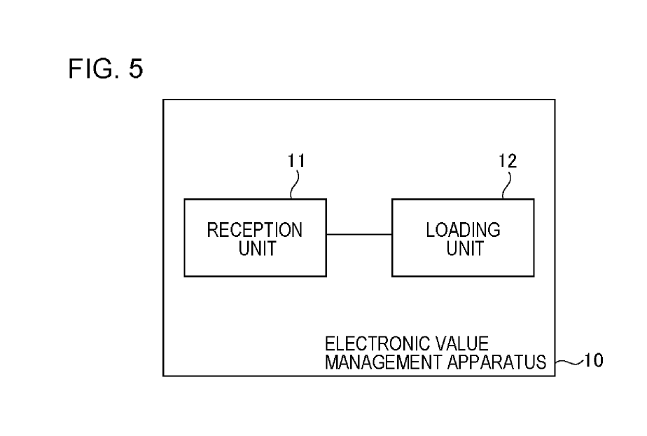

FIG. 5 shows an example of a functional block diagram of the electronic value management apparatus 10 of the present example embodiment. As shown in FIG. 5, the electronic value management apparatus 10 includes a reception unit 11 and a loading unit 12.

The reception unit 11 receives an input of a load amount which is the amount of the electronic value to be loaded. An operator (for example, a clerk of a member store or a customer) operates a predetermined input device (for example, a touch panel display, a physical button, a keyboard, a mouse, a microphone, or the like) and inputs the load amount. In this manner, the reception unit 11 acquires the load amount input from the operator.

The loading unit 12 performs a loading process of subtracting the load amount from the balance of an electronic value of a providing entity stored in a first storage unit and adding the load amount to the balance of an electronic value of a receiving entity stored in a second storage unit. Note that, in a case where the balance of the electronic value stored in the first storage unit is less than the load amount, the loading unit 12 does not execute the loading process. In this case, the loading unit 12 may output an error. The error can be output using any output device such as a display, a warning lamp, or a speaker.

In the case of the application example of the present example embodiment, the providing entity is a member store and the receiving entity is a customer. The first storage unit is a storage unit of the portable storage apparatus 30 (in the case of FIG. 4, a store card) of the member store, and the second storage unit is a storage unit of the portable storage apparatus 30 (in the case of FIG. 4, a customer card) of a customer.

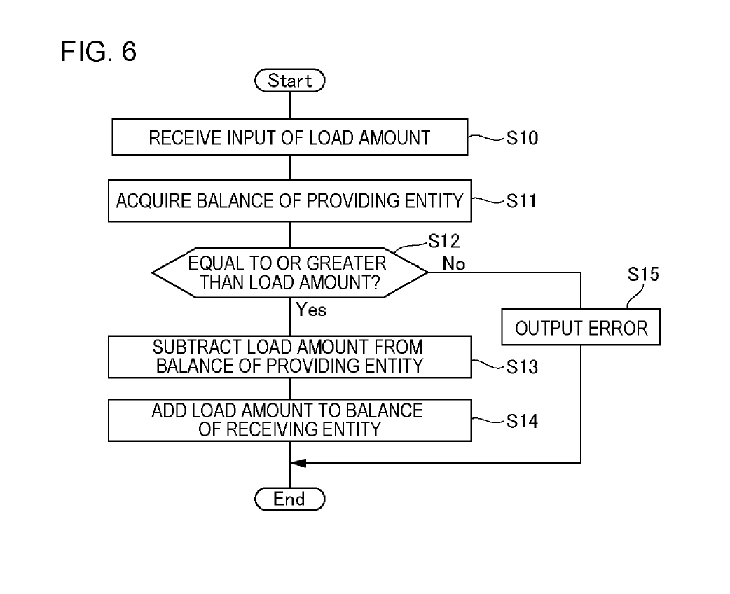

Next, with reference to the flowchart of FIG. 6, an example of the flow of a loading process will be described.

First, the customer pays a predetermined amount of cash to the member store and requests to load the electronic value. Then, for example, the clerk of a member store operates a predetermined input device (for example, a touch panel display, a physical button, a keyboard, a mouse, a microphone, or the like) and inputs the load amount. The reception unit 11 acquires the load amount input in this way (S10).

Thereafter, the clerk of the member store makes the portable storage apparatus 30 of the member store and the electronic value management apparatus 10 communicable. Then, the loading unit 12 acquires the balance of the electronic value stored in the portable storage apparatus 30 (S11).

In a case where the balance acquired in S11 is not equal to or greater than the load amount acquired in S10 (No in S12), the loading unit 12 outputs an error indicating insufficient balance (S15). Then, the process is terminated.

On the other hand, in a case where the balance acquired in S11 is equal to or greater than the load amount acquired in S10 (Yes in S12), the loading unit 12 subtracts the load amount acquired in S10 from the balance of the electronic value stored in the portable storage apparatus of the member store (S13).

Thereafter, the customer makes the portable storage apparatus 30 of the customer and the electronic value management apparatus 10 communicable. Then, the loading unit 12 adds the load amount acquired in S10 to the balance of the electronic value stored in the portable storage apparatus 30 (S14).

Thus, the loading process is completed.

It should be noted that in a case where the electronic value management apparatus and the portable storage apparatus 30 of the customer cannot communicate even after a predetermined time, after S13, the electronic value management apparatus 10 may add the load amount acquired in S10 to the balance of the online account of the member store (request the account management server 20) and end the process.

In this case, the electronic value management apparatus 10 needs to acquire the account identification information of the online account of the member store. For example, account identification information of the online account of the member store may be stored in advance in the electronic value management apparatus 10. In addition, the account identification information of the online account of a member store is stored in the portable storage apparatus of the member store, and the electronic value management apparatus 10 may acquire the account identification information from the portable storage apparatus 30 of the member store at the time of process of S11.

In the case of the present example embodiment described above, the member store has authority to load for an electronic value corresponding to the amount paid in advance by cash to the branch. In the case of this system, it is possible to suppress inconvenience such as a member store running off with cash (cash paid to a member store by a customer for loading) and illegally loading.

Further, in the case of the present example embodiment, the loading process can be performed in the form of transferring from the portable storage apparatus 30 of the member store to the portable storage apparatus 30 of the customer. That is, the loading process can be performed offline. Therefore, even in a situation where the environment of the network 40 is poor and it is difficult to always maintain connection to the account management server 20, the loading process can be smoothly progressed.

As a modification example of the present example embodiment, the member store may be a store having the settlement terminal described above. That is, in addition to a loading service of an electronic value, the member store may also be a store that provides a settlement service using an electronic value.

Then, in addition to the electronic value acquired from the branch by paying cash, the member store may use the electronic value acquired from the customer in settlement for a loading service. As described above, in the settlement, the payment amount is subtracted from the balance of the electronic value stored in the portable storage apparatus 30 of a customer, and the payment amount is added to the electronic value on the store side stored in the predetermined storage apparatus. For example, the payment amount is added to the electronic value of the online account of the store managed by the account management server 20. The member store may use the electronic value acquired from the customer in the settlement for the above-described loading. Note that, the modification example can be applied to all the following example embodiments.

According to the modification example, it is possible to reduce the exchange of cash and electronic value for a loading service between a member store and a branch. As a result, various costs required for the exchange can be reduced.

### Second Example Embodiment

The overview of the electronic value management system of the present example embodiment is the same as that of the first example embodiment described with reference to FIG. 2.

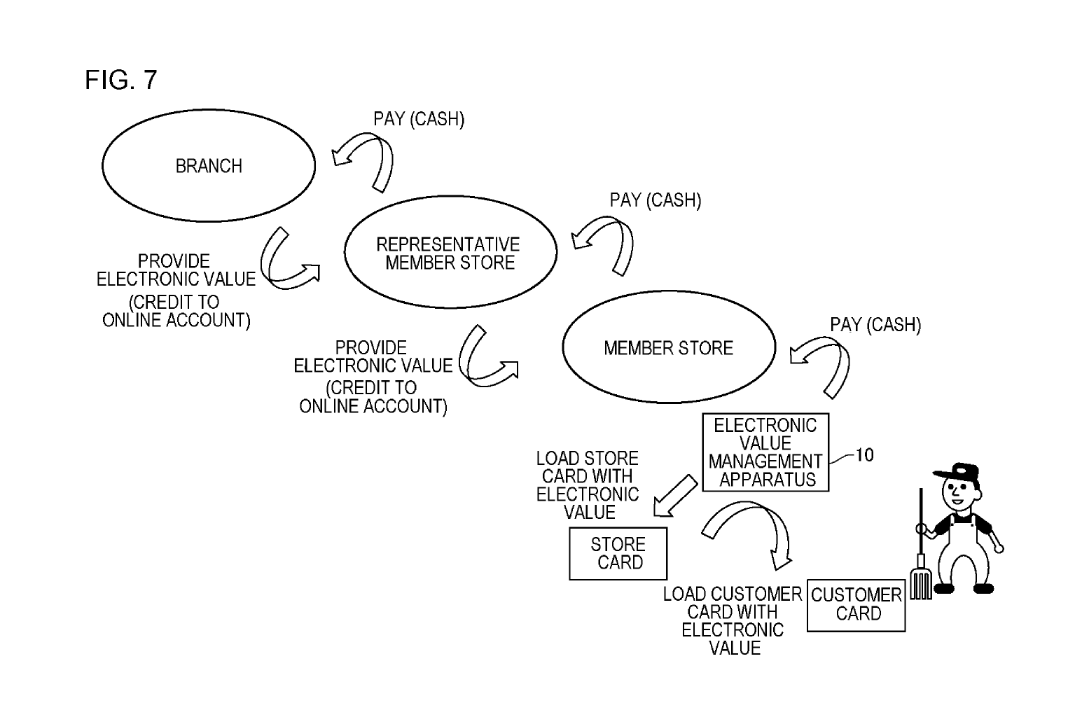

Next, an application example of the electronic value management system of the present example embodiment will be described with reference to FIG. 7. Four types of entities appear: a branch, a representative member store, a member store, and a customer.

The branch is an entity that manages issuance of an electronic value. The branch gives authority to cultivate a member store and authority to manage member stores, to a plurality of representative member stores. The representative member store cultivates member stores and manages the member stores that have been cultivated.

The branch may give authority to load over customers, to the member stores cultivated by the representative member store. As another example, the branch may give the representative member store authority to give the authority to load. Then, the representative member store may give the authority to load over customers, to the member stores.

The representative member store pays a predetermined amount of cash to the branch. The branch credits the electronic value of the amount corresponding to the paid amount, to the online account of the representative member store.

The member store pays a predetermined amount of cash to the representative member store. The representative member store credits the electronic value of the amount corresponding to the paid amount, to the online account of the member store.

The member store has a portable storage apparatus 30 for a store. The member store transfers at least a part of the electronic value remaining in the online account of the member store to the portable storage apparatus 30 through the electronic value management apparatus 10. This process is the same as that in the first example embodiment.

The customer pays a predetermined amount of cash to the member store and requests to load the electronic value. The loading is performed through the electronic value management apparatus 10. The configuration of the electronic value management apparatus 10 and the flow of a loading process from a member store to a customer are the same as in the first example embodiment.

According to the present example embodiment described above, the same advantageous effects as those of the first example embodiment can be realized.

### Third Example Embodiment

The overview of the electronic value management system of the present example embodiment is the same as that of the first example embodiment described with reference to FIG. 2.

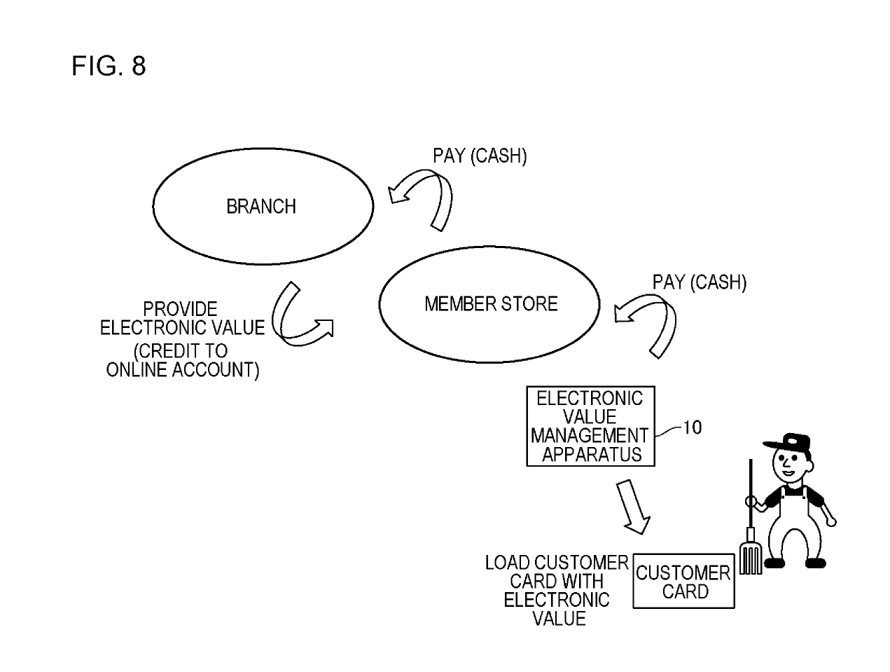

Next, an application example of the electronic value management system of the present example embodiment will be described with reference to FIG. 8. Three types of entities appear: a branch, a member store, and a customer.

The branch is an entity that manages issuance of an electronic value. The branch gives authority to load over customers to a plurality of member stores.

A member store given the authority to load pays a predetermined amount of cash to the branch. The branch credits the electronic value of the amount corresponding to the paid amount, to the online account of the member store.

The customer pays a predetermined amount of cash to the member store and requests to load the electronic value. The loading is performed through the electronic value management apparatus 10. Hereinafter, the configuration of the electronic value management apparatus 10 will be described in detail.

FIG. 5 shows an example of a functional block diagram of the electronic value management apparatus 10 of the present example embodiment. As shown in FIG. 5, the electronic value management apparatus 10 includes a reception unit 11 and a loading unit 12. The configuration of the reception unit 11 is the same as that in the first and second example embodiments.

The loading unit 12 performs a loading process of subtracting the load amount from a balance of an electronic value of a providing entity stored in a first storage unit and adding the load amount to a balance of an electronic value of a receiving entity stored in a second storage unit. Note that, in a case where the balance of the electronic value stored in the first storage unit is less than the load amount, the loading unit 12 does not execute the loading process. In this case, the loading unit 12 may output an error. The error can be output using any output device such as a display, a warning lamp, or a speaker.

In the case of the application example of the present example embodiment, the providing entity is a member store and the receiving entity is a customer. The first storage unit is a storage unit included by the account management server 20 (see FIG. 2), and the second storage unit is a storage unit included by the portable storage apparatus 30 (in the case of FIG. 8, a customer card) of a customer.

Next, with reference to the flowchart of FIG. 6, an example of the flow of a loading process will be described.

First, the customer pays a predetermined amount of cash to the member store and requests to load the electronic value. Then, for example, the clerk of a member store operates a predetermined input device (for example, a touch panel display, a physical button, a keyboard, a mouse, a microphone, or the like) and inputs the load amount. The reception unit 11 acquires the load amount input in this way (S10).

Thereafter, the loading unit 12 acquires account information (balance or the like) corresponding to the account identification information of the online account of the member store from the account management server 20 (S11). For example, account identification information of the online account of the member store may be stored in advance in the electronic value management apparatus 10. Alternatively, the clerk of the member store may input the account identification information of the online account of the member store to the electronic value management apparatus 10 by any means. The loading unit 12 requests account information corresponding to the account identification information acquired in this way from the account management server 20 and acquires it.

In a case where the balance acquired in S11 is not equal to or greater than the load amount acquired in S10 (No in S12), the loading unit 12 outputs an error indicating insufficient balance (S15). Then, the process is terminated.

On the other hand, in a case where the balance acquired in S11 is equal to or greater than the load amount acquired in S10 (Yes in S12), the loading unit 12 subtracts the load amount acquired in S10 from the balance of the electronic value of the online account of the member store (S13). The loading unit 12 achieves the process by requesting the account management server 20 to subtract the load amount acquired in S10 from the balance of the electronic value of the member store.

Thereafter, the customer makes the portable storage apparatus 30 of the customer and the electronic value management apparatus 10 communicable. Then, the loading unit 12 adds the load amount acquired in S10 to the balance of the electronic value stored in the portable storage apparatus 30 (S14).

Thus, the loading process is completed.

It should be noted that in a case where the electronic value management apparatus and the portable storage apparatus 30 of the customer cannot communicate even after a predetermined time, after S13, the electronic value management apparatus 10 may add the load amount acquired in S10 to the balance of the online account of the member store and end the process.

In the case of the present example embodiment described above, the same operational effect as those of the first and second example embodiments can be realized. Further, the electronic value of the member store can be managed by the account management server 20. Therefore, it is possible to suppress fraud such as rewriting data on the portable storage apparatus 30 of the member store.

### Fourth Example Embodiment

The overview of the electronic value management system of the present example embodiment is the same as that of the first example embodiment described with reference to FIG. 2.

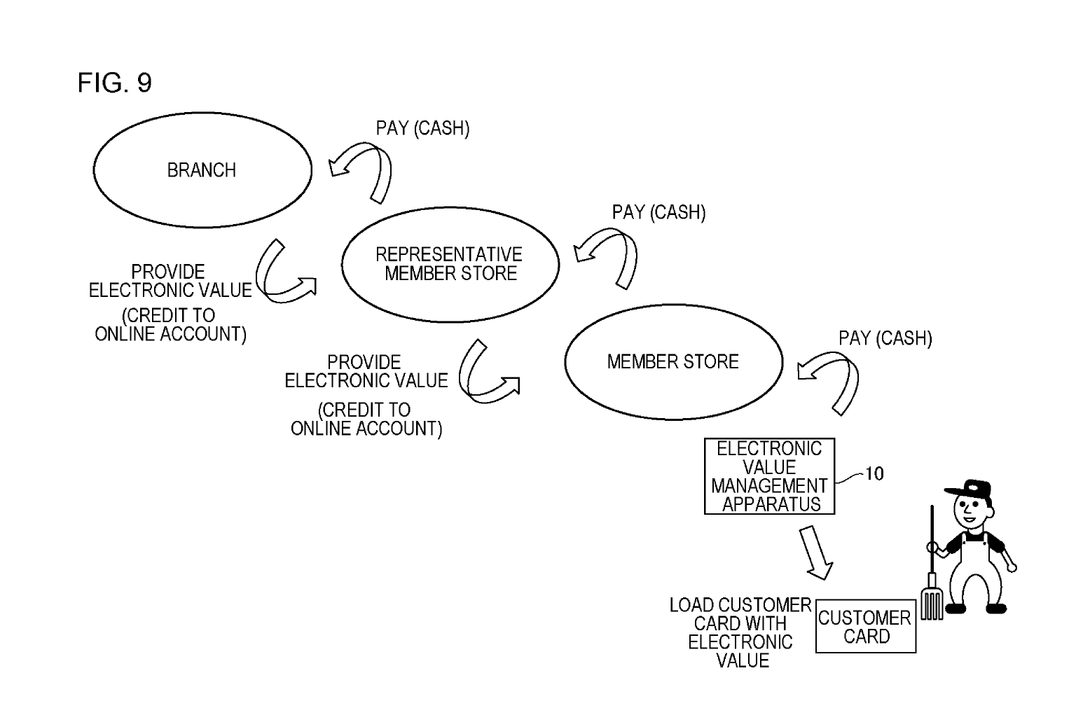

Next, an application example of the electronic value management system of the present example embodiment will be described with reference to FIG. 9. Four types of entities appear: a branch, a representative member store, a member store, and a customer.

The branch is an entity that manages issuance of an electronic value. The branch gives authority to cultivate a member store and authority to manage member stores, to a plurality of representative member stores. The representative member store cultivates member stores and manages the member stores that have been cultivated.

The branch may give authority to load over customers, to the member stores cultivated by the representative member store. As another example, the branch may give the representative member store the authority to give the authority to load. Then, the representative member store may give the authority to load over customers, to the member stores.

The representative member store pays a predetermined amount of cash to the branch. The branch credits the electronic value of the amount corresponding to the paid amount, to the online account of the representative member store.

The member store pays a predetermined amount of cash to the representative member store. The representative member store credits the electronic value of the amount corresponding to the paid amount, to the online account of the member store.

The customer pays a predetermined amount of cash to the member store and requests to load the electronic value. The loading is performed through the electronic value management apparatus 10.

The configuration of the electronic value management apparatus 10 and the flow of a loading process from a member store to a customer are the same as in the third example embodiment.

According to the present example embodiment described above, the same advantageous effects as those of the first to third example embodiments can be realized.

### Fifth Example Embodiment

In the present example embodiment, the electronic value can be restricted in use. The electronic value which is restricted in use can only be used for the purpose. In the present example embodiment, by using the technique inconveniences can be alleviated which may occur in connection with a loading process of an electronic value.

First, a technique for restricting the use of an electronic value will be described. In the present example embodiment, use information indicating the use of the electronic value can be associated with the balance of the electronic value stored in the account management server 20 or the portable storage apparatus 30. The electronic value is restricted to use indicated by corresponding use information.

The value of the use information can be a code value. In the present example embodiment, the code value is color, but it is only an example, and the code value is not limited thereto.

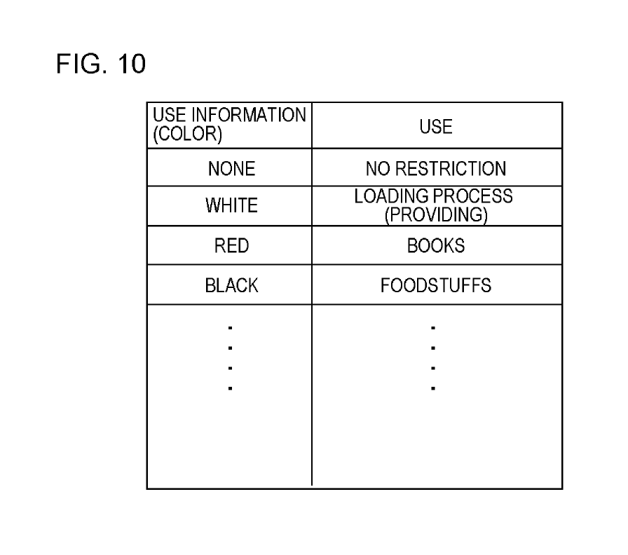

FIG. 10 shows an example of the use information of the present example embodiment represented by the code value. As shown in FIG. 10, each color (code value) corresponds to the use of electronic value.

In the case of the illustrated example, the electronic value associated with the use information “no color” can be used with no restrictions on usage. The electronic value associated with the use information “white” is restricted to use in the loading process (providing) described in the first to fourth example embodiments. That is, the electronic value associated with the use information cannot be used for shopping, or the like, and only the loading for the customer is permitted. The electronic value associated with the use information “red” is restricted to use in purchasing books. The electronic value associated with the use information “black” is restricted to use in purchasing foodstuffs.

It should be noted that, the above-described example is merely an example, and other examples are also conceivable. For example, the use may be restricted to available stores. For example, the electronic value associated with the use information “brown” is restricted to use at stores affiliated to the group A, and the electronic value associated with the use information “green” is restricted to use at book stores.

In addition, the electronic value associated with the use information “blue” is an electronic value provided to the employee from the company in order to subsidize lunch fee, and, for example, restriction on use to a predetermined restaurant (for example, a cafeteria), purchase of foodstuffs, or the like is conceivable. In addition, the electronic value associated with the use information “purple” is an electronic value provided to the employee from the company in order to subsidize transportation fee, and, for example, restriction on use to public transportation, taxis, or the like is conceivable.

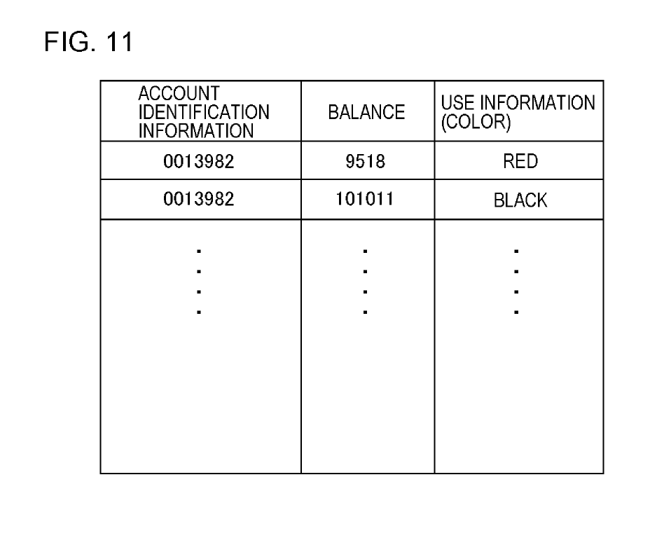

FIG. 11 shows an example of information managed by the account management server 20 of the present example embodiment. As shown in FIG. 11, the account identification information, the balance, and the use information are associated with each other. Note that, as shown in FIG. 11, a plurality of types of electronic values associated with different types of use information may be managed in one online account, or one type of electronic value associated with one type of use information may be managed in one online account. Likewise, the portable storage apparatus 30 also stores information in which the balance and use information are associated with each other.

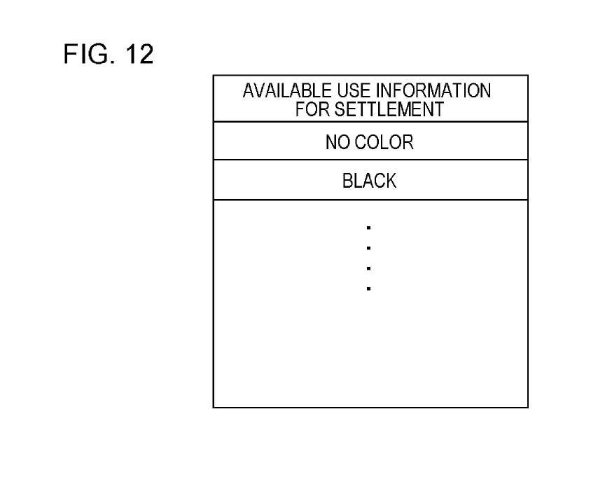

The settlement at the store using the electronic value is performed as follows. For example, the electronic value that can be used may be determined for each store. In this case, the use information as shown in FIG. 12 is stored in advance in the settlement terminal of each store or in the apparatus communicably connected to the settlement terminal of each store. The settlement terminal permits use of only the electronic value associated with the use information (available use information for settlement) in settlement.

For example, at the time of settlement, the settlement terminal communicates with the portable storage apparatus 30 of a customer and acquires the balance and use information. Then, in a case where the use information acquired from the portable storage apparatus 30 of a customer matches the available use information for settlement, the settlement process using the electronic value is executed. Specifically, the settlement amount is subtracted from the balance stored in the portable storage apparatus 30 of the customer, and the settlement amount is added to the balance of the electronic value of the store stored in the predetermined storage apparatus.

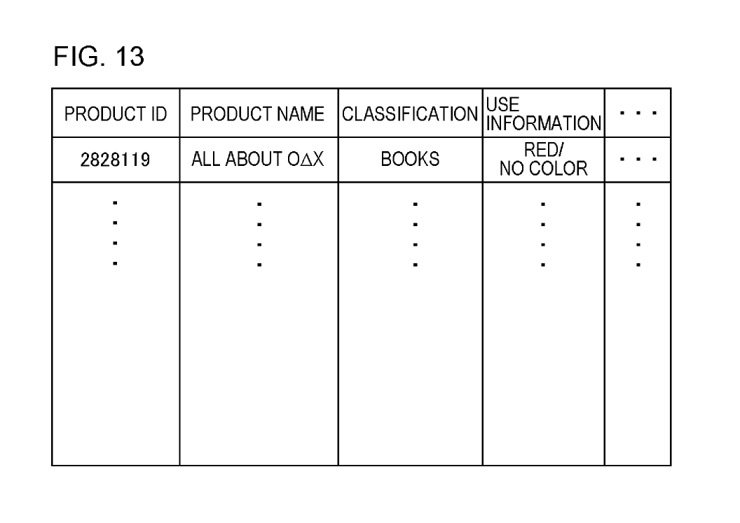

In addition, the electronic value that can be used may be determined for each product. In this case, the settlement terminal uses the product information as shown in FIG. 13 for a settlement process. The product information is information on products handled in each store, and a product identifier (ID), a product name, a classification, and use information corresponding to each classification are associated with each other. In the settlement of each product, it is possible to use an electronic value associated with the use information corresponding to each product. In the case of the illustrated example, it means that the electronic value associated with the use information “red” and the electronic value associated with the use information “no color” can be used in the settlement of the book with the product ID “2828119” and the subject “all about OΔx”.

At the time of settlement, the settlement terminal communicates with the portable storage apparatus 30 of a customer and acquires the balance and use information. Then, in a case where the use information acquired from the portable storage apparatus 30 of a customer matches the use information of a product to be settled, the settlement process using the electronic value is executed. Specifically, the settlement amount is subtracted from the balance stored in the portable storage apparatus 30 of the customer, and the settlement amount is added to the balance of the electronic value of the store stored in the predetermined storage apparatus.

Next, a configuration that alleviates inconveniences that may occur in connection with a loading process of an electronic value, using the technique will be described.

The overview of the electronic value management system of the present example embodiment is the same as that of the first example embodiment described with reference to FIG. 2.

Next, an application example of the electronic value management system of the present example embodiment will be described with reference to FIG. 4. Three types of entities appear: a branch, a member store, and a customer.

The branch is an entity that manages issuance of an electronic value. The branch gives authority to load over customers to a plurality of member stores.

A member store given the authority to load pays a predetermined amount of cash to the branch. The branch credits the electronic value of the amount corresponding to the paid amount, to the online account of the member store.

The member store has a portable storage apparatus 30 for a store. The member store transfers at least a part of the electronic value remaining in the online account of the member store to the portable storage apparatus 30 through the electronic value management apparatus 10. At this time, the use information restricting the use to “loading process (providing)” is associated with the electronic value transferred to the portable storage apparatus 30.

More specifically, the clerk of a member store (for example, a manager such as a store manager) operates a predetermined input device (for example, a touch panel display, a physical button, a keyboard, a mouse, a microphone, or the like) to input the account identification information of the online account of the store, the amount (transfer amount) of the electronic value to be transferred to the portable storage apparatus 30, and use information associated with the electronic value (use information restricting the use to “loading process (providing)”) to the electronic value management apparatus 10. Then, the electronic value management apparatus 10 transmits to the account management server 20, a transfer request of an electronic value for the above-described transfer amount from the online account corresponding to the input account identification information to the portable storage apparatus 30. Here, in a case where the balance is less than the transfer amount, the account management server 20 transmits an error such as “insufficient balance” to the electronic value management apparatus 10. Then, the electronic value management apparatus 10 outputs the error.

In a case where the error has not occurred, the account management server 20 transmits a transfer permission to the electronic value management apparatus 10. Then, the electronic value management apparatus 10 outputs a guide for causing the portable storage apparatus 30 to communicate with the electronic value management apparatus 10. Thereafter, the clerk of the member store makes the portable storage apparatus 30 and the electronic value management apparatus 10 communicable. Then, the transfer amount is added to the balance of the electronic value associated with use information restricting the use to “loading process (providing)” stored in the portable storage apparatus 30, and a transfer completion notification is transmitted from the electronic value management apparatus 10 to the account management server 20. Accordingly, the account management server 20 subtracts the transfer amount from the balance of the online account of the store.

As another example, account identification information of an online account of a member store may be stored in the portable storage apparatus 30 of the member store. The clerk of a member store (for example, a manager such as a store manager) operates a predetermined input device (for example, a touch panel display, a physical button, a keyboard, a mouse, a microphone, or the like) to input the amount (transfer amount) of the electronic value to be transferred to the portable storage apparatus 30, and use information associated with the electronic value (use information restricting the use to “loading process (providing)”) to the electronic value management apparatus 10.

Thereafter, the clerk makes the portable storage apparatus 30 and the electronic value management apparatus 10 communicable. Then, the electronic value management apparatus 10 acquires the account identification information of the online account of the member store stored in the portable storage apparatus 30. Then, the electronic value management apparatus 10 transmits to the account management server 20, a transfer request of an electronic value for the above-described transfer amount from the online account corresponding to the input account identification information to the portable storage apparatus 30. The subsequent process is the same as above.

The customer pays a predetermined amount of cash to the member store and requests to load the electronic value. The loading is performed through the electronic value management apparatus 10. Hereinafter, the configuration of the electronic value management apparatus 10 will be described in detail.

FIG. 5 shows an example of a functional block diagram of the electronic value management apparatus 10 of the present example embodiment. As shown in FIG. 5, the electronic value management apparatus 10 includes a reception unit 11 and a loading unit 12. The configuration of the reception unit 11 is the same as those in the first to fourth example embodiments.

The loading unit 12 performs a loading process of subtracting the load amount from a balance of an electronic value of a providing entity stored in the first storage unit and adding the load amount to a balance of an electronic value of a receiving entity stored in the second storage unit. Note that, in a case where the balance of the electronic value stored in the first storage unit is less than the load amount, the loading unit 12 does not execute the loading process. In this case, the loading unit 12 may output an error. The error can be output using any output device such as a display, a warning lamp, or a speaker.

In the loading process, the loading unit 12 may subtract the load amount from a balance of the electronic value associated with the use information restricting the use to the loading process stored in the first storage unit, and add the load amount to a balance of the electronic value of which is not associated with the use information restricting the use to the loading process stored in the second storage unit. That is, in a case where the electronic value is transferred by the loading process through the electronic value management apparatus 10, the contents of the use information associated with the electronic value may be changed.

In the case of the application example of the present example embodiment, the providing entity is a member store and the receiving entity is a customer. The first storage unit is a storage unit of the portable storage apparatus 30 of the member store, and the second storage unit is a storage unit of the portable storage apparatus 30 of a customer.

The flow of the loading process from the member store to the customer is the same as in the first example embodiment.

According to the present example embodiment described above, the same advantageous effects as those of the first to fourth example embodiments can be realized. Further, according to the present example embodiment, the electronic value stored in the portable storage apparatus 30 of the member store for a loading process is associated with the use information restricting the use to the loading process, and it is possible to restrict the use other than the loading process. According to the present example embodiment as described above, the occurrence of the run off with the portable storage apparatus 30 by the clerk of the member store can be reduced.

Further, according to the present example embodiment, the use information can be represented by color. In such a case, the user of the electronic value can recognize the use of the electronic value possessed by the user, an electronic value that can be used for shopping at each store, or the like from color. Therefore, it is possible to intuitively recognize the attribute of electronic value and availability at each store.

### Sixth Example Embodiment

The overview of the electronic value management system of the present example embodiment is the same as that of the first example embodiment described with reference to FIG. 2.

Next, an application example of the electronic value management system of the present example embodiment will be described with reference to FIG. 7. Four types of entities appear: a branch, a representative member store, a member store, and a customer.

The branch is an entity that manages issuance of an electronic value. The branch gives authority to cultivate a member store and authority to manage member stores, to a plurality of representative member stores. The representative member store cultivates member stores and manages the member stores that have been cultivated.

The branch may give authority to load over customers, to the member stores cultivated by the representative member store. As another example, the branch may give the representative member store the authority to give the authority to load. Then, the representative member store may give the authority to load over customers, to the member stores.

The representative member store pays a predetermined amount of cash to the branch. The branch credits the electronic value of the amount corresponding to the paid amount, to the online account of the representative member store.

The member store pays a predetermined amount of cash to the representative member store. The representative member store credits the electronic value of the amount corresponding to the paid amount, to the online account of the member store.

The member store has a portable storage apparatus 30 for a store. The member store transfers at least a part of the electronic value remaining in the online account of the member store to the portable storage apparatus 30 through the electronic value management apparatus 10. At this time, the use information restricting the use to “loading process (providing)” is associated with the electronic value transferred to the portable storage apparatus 30. This process is the same as that in the fifth example embodiment.

The customer pays a predetermined amount of cash to the member store and requests to load the electronic value. The loading is performed through the electronic value management apparatus 10. The configuration of the electronic value management apparatus 10 is the same as that in the fifth example embodiment. The flow of the loading process from the member store to the customer is the same as in the second example embodiment.

According to the present example embodiment described above, the same advantageous effects as those of the first to fifth example embodiments can be realized.

### Seventh Example Embodiment

The overview of the electronic value management system of the present example embodiment is the same as that of the first example embodiment described with reference to FIG. 2.

Next, an application example of the electronic value management system of the present example embodiment will be described with reference to FIG. 8. Three types of entities appear: a branch, a member store, and a customer.

The branch is an entity that manages issuance of an electronic value. The branch gives authority to load over customers to a plurality of member stores.

A member store given the authority to load pays a predetermined amount of cash to the branch. The branch credits the electronic value of the amount corresponding to the paid amount, to the online account of the member store. The clerk of a member store (for example, a manager such as a store manager) operates a predetermined terminal to associate use information restricting the use to the loading process (providing) with the electronic value credited to the online account of the store. Note that, the branch may credit the electronic value associated with predetermined use information (use information restricting the use to “loading process (providing)”) to the online account of the member store.

The customer pays a predetermined amount of cash to the member store and requests to load the electronic value. The loading is performed through the electronic value management apparatus 10. Hereinafter, the configuration of the electronic value management apparatus 10 will be described in detail.

FIG. 5 shows an example of a functional block diagram of the electronic value management apparatus 10 of the present example embodiment. As shown in FIG. 5, the electronic value management apparatus 10 includes a reception unit 11 and a loading unit 12. The configuration of the reception unit 11 is the same as those in the first to sixth example embodiments.

The loading unit 12 performs a loading process of subtracting the load amount from a balance of an electronic value of a providing entity stored in the first storage unit and adding the load amount to a balance of an electronic value of a receiving entity stored in the second storage unit. Note that, in a case where the balance of the electronic value stored in the first storage unit is less than the load amount, the loading unit 12 does not execute the loading process. In this case, the loading unit 12 may output an error. The error can be output using any output device such as a display, a warning lamp, or a speaker.

In the loading process, the loading unit 12 may subtract the load amount from a balance of the electronic value associated with the use information restricting the use to the loading process stored in the first storage unit, and add the load amount to a balance of the electronic value of which is not associated with the use information restricting the use to the loading process stored in the second storage unit. That is, in a case where the electronic value is transferred by the loading process through the electronic value management apparatus 10, the contents of the use information associated with the electronic value may be changed.

In the case of the application example of the present example embodiment, the providing entity is a member store and the receiving entity is a customer. The first storage unit is a storage unit of the account management server 20 (see FIG. 2), and the second storage unit is a storage unit of the portable storage apparatus 30 of a customer.

The flow of the loading process from the member store to the customer is the same as in the third example embodiment.

According to the present example embodiment described above, the same advantageous effects as those of the first to sixth example embodiments can be realized. Further, according to the present example embodiment, the electronic value credited from the branch to the member store for a loading process is associated with the use information restricting the use to the loading process, and it is possible to restrict the use other than the loading process. According to the present example embodiment as described above, it is possible to reduce the occurrence of the run off with an electronic value from the on-line account of a member store.

### Eighth Example Embodiment

The overview of the electronic value management system of the present example embodiment is the same as that of the first example embodiment described with reference to FIG. 2.

Next, an application example of the electronic value management system of the present example embodiment will be described with reference to FIG. 9. Four types of entities appear: a branch, a representative member store, a member store, and a customer.

The branch is an entity that manages issuance of an electronic value. The branch gives authority to cultivate a member store and authority to manage member stores, to a plurality of representative member stores. The representative member store cultivates member stores and manages the member stores that have been cultivated.

The branch may give authority to load over customers, to the member stores cultivated by the representative member store. As another example, the branch may give the representative member store the authority to give the authority to load. Then, the representative member store may give the authority to load over customers, to the member stores.

The representative member store pays a predetermined amount of cash to the branch. The branch credits the electronic value of the amount corresponding to the paid amount, to the online account of the representative member store.

The member store pays a predetermined amount of cash to the representative member store. The representative member store credits the electronic value of the amount corresponding to the paid amount, to the online account of the member store. The clerk of a member store (for example, a manager such as a store manager) operates a predetermined terminal to associate use information restricting the use to the loading process (providing) with the electronic value credited to the online account of the store. Note that, the representative member store may credit the electronic value associated with predetermined use information (use information restricting the use to “loading process (providing)”) to the online account of the member store.

The customer pays a predetermined amount of cash to the member store and requests to load the electronic value. The loading is performed through the electronic value management apparatus 10. The configuration of the electronic value management apparatus 10 is the same as that in the seventh example embodiment. The flow of the loading process from the member store to the customer is the same as in the fourth example embodiment.

According to the present example embodiment described above, the same advantageous effects as those of the first to seventh example embodiments can be realized.

Examples of a reference aspect will be added below.

1. An electronic value management apparatus including:

a reception unit that receives an input of a load amount;

a loading unit that performs a loading process of subtracting the load amount from a balance of an electronic value of a providing entity stored in a first storage unit and adding the load amount to a balance of an electronic value of a receiving entity stored in a second storage unit.

2. The electronic value management apparatus according to 1.,

wherein the loading unit outputs an error without performing the loading process, in a case where the balance of the electronic value stored in the first storage unit is less than the load amount.

3. The electronic value management apparatus according to 1. or 2.,

wherein a portable storage apparatus includes the second storage unit, and

wherein the loading unit communicates with the portable storage apparatus to update information stored in the second storage unit.

4. The electronic value management apparatus according to any one of 1. to 3.,

wherein a portable storage apparatus includes the first storage unit, and

wherein the loading unit communicates with the portable storage apparatus to update information stored in the first storage unit.

5. The electronic value management apparatus according to any one of 1. to 3.,

wherein a server includes the first storage unit, and the first storage unit stores the balance of the electronic value in association with providing entity identification information of each of a plurality of providing entities, and

wherein the loading unit communicates with the server to update the balance of the electronic value associated with the predetermined providing entity identification information.

6. The electronic value management apparatus according to any one of 1. to 5.,

wherein the electronic value can be associated with use information indicating use of the electronic value, and the electronic value associated with the use information is restricted to the use indicated by the use information, and

wherein the electronic value stored in the first storage unit is associated with the use information restricting the use to the loading process.

7. The electronic value management apparatus according to 6.,

wherein in the loading process, the loading unit subtracts the load amount from a balance of the electronic value which is associated with the use information restricting the use to the loading process and which is stored in the first storage unit, and adds the load amount to the balance of the electronic value which is not associated with the use information restricting the use to the loading process and which is stored in the second storage unit.

8. An electronic value management system including:

the electronic value management apparatus according to any one of 1. to 7.;

an apparatus having a first storage unit that stores a balance of an electronic value of a providing entity; and

an apparatus having a second storage unit that stores a balance of an electronic value of a receiving entity.

9. An electronic value management method executed by a computer, the method including:

a reception step of receiving an input of a load amount; and

a loading step of performing a loading process of subtracting the load amount from a balance of an electronic value of a providing entity stored in a first storage unit and adding the load amount to a balance of an electronic value of a receiving entity stored in a second storage unit.

9-2. The electronic value management method according to 9.,

wherein in the loading step, the loading process is not performed and an error is output, in a case where the balance of the electronic value stored in the first storage unit is less than the load amount.

9-3. The electronic value management method according to 9. or 9-2.,

wherein a portable storage apparatus includes the second storage unit, and

wherein in the loading step, communication with the portable storage apparatus is performed, and information stored in the second storage unit is updated.

9-4. The electronic value management method according to any one of 9. to 9-3.,

wherein a portable storage apparatus includes the first storage unit, and

wherein in the loading step, communication with the portable storage apparatus is performed, and information stored in the first storage unit is updated.

9-5. The electronic value management method according to any one of 9. to 9-3.,

wherein a server includes the first storage unit, and the first storage unit stores the balance of the electronic value in association with providing entity identification information of each of a plurality of providing entities, and

wherein in the loading step, communication with the server is performed, and the balance of the electronic value associated with the predetermined providing entity identification information is updated.

9-6. The electronic value management method according to any one of 9. to 9-5.,

wherein the electronic value can be associated with use information indicating use of the electronic value, and the electronic value associated with the use information is restricted to the use indicated by the use information, and

wherein the electronic value stored in the first storage unit is associated with the use information restricting the use to the loading process.

9-7. The electronic value management method according to 9-6.,

wherein in the loading step, in the loading process, the load amount is subtracted from the balance of the electronic value which is associated with the use information restricting the use to the loading process and which is stored in the first storage unit, and the load amount is added to the balance of the electronic value which is not associated with the use information restricting the use to the loading process and which is stored in the second storage unit.

10. A program causing a computer to function as:

a reception unit that receives an input of a load amount;

a loading unit that performs a loading process of subtracting the load amount from a balance of an electronic value of a providing entity stored in a first storage unit and adding the load amount to a balance of an electronic value of a receiving entity stored in a second storage unit.

10-2. The program according to 10.,

wherein the loading unit outputs an error without performing the loading process, in a case where the balance of the electronic value stored in the first storage unit is less than the load amount.

10-3. The program according to 10. or 10-2.,

wherein a portable storage apparatus includes the second storage unit, and

wherein the loading unit communicates with the portable storage apparatus to update information stored in the second storage unit.

10-4. The program according to any one of 10. to 10-3.,

wherein a portable storage apparatus includes the first storage unit, and

wherein the loading unit communicates with the portable storage apparatus to update information stored in the first storage unit.

10-5. The program according to any one of 10. to 10-3.,

wherein a server includes the first storage unit, and the first storage unit stores the balance of the electronic value in association with providing entity identification information of each of a plurality of providing entities, and

wherein the loading unit communicates with the server to update the balance of the electronic value associated with the predetermined providing entity identification information.

10-6. The program according to any one of 10. to 10-5.,

wherein the electronic value can be associated with use information indicating use of the electronic value, and the electronic value associated with the use information is restricted to the use indicated by the use information, and

wherein the electronic value stored in the first storage unit is associated with the use information restricting the use to the loading process.

10-7. The program according to 10-6.,

wherein in the loading process, the loading unit subtracts the load amount from the balance of the electronic value which is associated with the use information restricting the use to the loading process and which is stored in the first storage unit, and adds the load amount to the balance of the electronic value which is not associated with the use information restricting the use to the loading process and which is stored in the second storage unit.

This application claims priority based on Japanese Patent Application No. 2016-046520 filed on Mar. 10, 2016, and the disclosure of which is incorporated herein in its entirety.

1. An electronic value management apparatus comprising:
at least one memory configured to store one or more instructions; and
at least one processor configured to execute the one or more instructions to:
receive an input of a load amount; and
perform a loading process of subtracting the load amount from a balance of an electronic value of a providing entity stored in a first memory and adding the load amount to a balance of an electronic value of a receiving entity stored in a second memory.

2. The electronic value management apparatus according to claim 1,
wherein the at least one processor is configured to output an error without performing the loading process, in a case where the balance of the electronic value stored in the first memory is less than the load amount.

3. The electronic value management apparatus according to claim 1,
wherein a portable storage apparatus includes the second memory, and
wherein the at least one processor is configured to communicate with the portable storage apparatus to update information stored in the second memory.

4. The electronic value management apparatus according to claim 1,
wherein a portable storage apparatus includes the first memory, and
wherein the at least one processor is configured to communicate with the portable storage apparatus to update information stored in the first memory.

5. The electronic value management apparatus according to claim 1,
wherein a server includes the first memory, and the first memory stores the balance of the electronic value in association with providing entity identification information of each of a plurality of providing entities, and
wherein the at least one processor is configured to communicate with the server to update the balance of the electronic value associated with a predetermined providing entity identification information.

6. The electronic value management apparatus according to claim 1,
wherein the electronic value can be associated with use information indicating use of the electronic value, and the electronic value associated with the use information is restricted to the use indicated by the use information, and
wherein the electronic value stored in the first memory is associated with the use information restricting the use to the loading process.

7. The electronic value management apparatus according to claim 6,
wherein the at least one processor is configured to:
in the loading process, subtract the load amount from the balance of the electronic value which is associated with the use information restricting the use to the loading process and which is stored in the first memory, and
add the load amount to the balance of the electronic value which is not associated with the use information restricting the use to the loading process and which is stored in the second memory.

8. An electronic value management system comprising:
the electronic value management apparatus according to claim 1;
an apparatus having a first memory that stores a balance of an electronic value of a providing entity; and
an apparatus having a second memory that stores a balance of an electronic value of a receiving entity.

9. An electronic value management method executed by a computer, the method comprising:
receiving an input of a load amount; and
performing a loading process of subtracting the load amount from a balance of an electronic value of a providing entity stored in a first memory and adding the load amount to a balance of an electronic value of a receiving entity stored in a second memory.

10. A non-transitory storage medium storing a program causing a computer to:
receive an input of a load amount;
perform a loading process of subtracting the load amount from a balance of an electronic value of a providing entity stored in a first memory and adding the load amount to a balance of an electronic value of a receiving entity stored in a second memory.

11. The electronic value management apparatus according to claim 2,
wherein a portable storage apparatus includes the second memory, and
wherein the at least one processor is configured to communicate with the portable storage apparatus to update information stored in the second memory.

12. The electronic value management apparatus according to claim 2,
wherein a portable storage apparatus includes the first memory, and
wherein the at least one processor is configured to communicate with the portable storage apparatus to update information stored in the first memory.

13. The electronic value management apparatus according to claim 3,
wherein a portable storage apparatus includes the first memory, and
wherein the at least one processor is configured to communicate with the portable storage apparatus to update information stored in the first memory.

14. The electronic value management apparatus according to claim 11,
wherein a portable storage apparatus includes the first memory, and
wherein the at least one processor is configured to communicate with the portable storage apparatus to update information stored in the first memory.

15. The electronic value management apparatus according to claim 2,
wherein a server includes the first memory, and the first memory stores the balance of the electronic value in association with providing entity identification information of each of a plurality of providing entities, and
wherein the at least one processor is configured to communicate with the server to update the balance of the electronic value associated with a predetermined providing entity identification information.

16. The electronic value management apparatus according to claim 3,
wherein a server includes the first memory, and the first memory stores the balance of the electronic value in association with providing entity identification information of each of a plurality of providing entities, and
wherein the at least one processor is configured to communicate with the server to update the balance of the electronic value associated with a predetermined providing entity identification information.

17. The electronic value management apparatus according to claim 11,
wherein a server includes the first memory, and the first memory stores the balance of the electronic value in association with providing entity identification information of each of a plurality of providing entities, and
wherein the at least one processor is configured to communicate with the server to update the balance of the electronic value associated with a predetermined providing entity identification information.

18. The electronic value management apparatus according to claim 2,
wherein the electronic value can be associated with use information indicating use of the electronic value, and the electronic value associated with the use information is restricted to the use indicated by the use information, and
wherein the electronic value stored in the first memory is associated with the use information restricting the use to the loading process.

19. The electronic value management apparatus according to claim 3,
wherein the electronic value can be associated with use information indicating use of the electronic value, and the electronic value associated with the use information is restricted to the use indicated by the use information, and
wherein the electronic value stored in the first memory is associated with the use information restricting the use to the loading process.

20. The electronic value management apparatus according to claim 4,
wherein the electronic value can be associated with use information indicating use of the electronic value, and the electronic value associated with the use information is restricted to the use indicated by the use information, and
wherein the electronic value stored in the first memory is associated with the use information restricting the use to the loading process.
